(19) United States
(12) Patent Application Publication
(10) Pub. No.: US 2017/0123743 A1
(43) Pub. Date: May 4, 2017

(54) METHOD AND ELECTRONIC DEVICE FOR INFORMATION DISPLAYING

(71) Applicants: Le Holdings (Beijing) Co., Ltd., Beijing (CN); Lemobile Information Technology (Beijing) Co., Ltd., Beijing (CN)

(72) Inventor: Qian ZHAO, Beijing (CN)

(21) Appl. No.: 15/247,663

(22) Filed: Aug. 25, 2016

Related U.S. Application Data
(63) Continuation of application No. PCT/CN2016/088452, filed on Jul. 4, 2016.

(30) Foreign Application Priority Data
Oct. 30, 2015 (CN) 201510734062X

(51) Int. Cl. G06F 3/14; H04N 7/18; G06T 11/60; G06F 3/0484; G06T 1/00; G06T 11/20

(52) U.S. Cl. CPC G06F 3/14; G06T 1/0007; G06T 11/203; G06T 11/60; G06F 3/04845; H04N 7/183

(57) ABSTRACT

Disclosed are a method and electronic device for information displaying, including: acquiring a target picture including an information to be prompted; processing the target picture to obtain a prompting picture; and displaying the prompting picture on a screen interface. According to the technical solution, a user does not need to manually input text information of a backlog, and instead the backlog is displayed on the screen interface of a mobile terminal by way of pictures and is prompted at an obvious position to prevent the user from forgetting important affairs and reduce user input at the same time, so that the method is simple and convenient to operate, the time for the user to set a prompt is saved, the prompting efficiency is improved, and better user experience for the mobile terminal is achieved.

### CROSS REFERENCE TO RELATED APPLICATIONS

This application is a continuation of International Application No. PCT/CN2016/088452, filed on Jul. 4, 2016, which is based upon and claims priority to Chinese Patent Application No. 201510734062.X, filed on Oct. 30, 2015, the entire contents of which are incorporated herein by reference.

### TECHNICAL FIELD

The present disclosure relates to the technical field of mobile terminals, in particular to a method and electronic device for information displaying.

### BACKGROUND

At present, there will be a lot of work required to be remembered in the busy and trivial daily life. But people's memory is limited and accordingly one thing that can prompt us and arrange our work is needed to orderly process and schedule tasks, and complete the most urgent and vital things within a time limit. But for the existing methods for reminding a user of backlogs, the user often needs to record the backlogs by words and elaborate on events, leading to great complexity. If the user is very busy and fails to quickly and accurately record the backlogs, the user cannot be effectively reminded.

### SUMMARY

The embodiment of the present disclosure provides a method and electronic device for information displaying. The technical solution is as follows:

According to the first aspect of the embodiment of the present disclosure, a method for information displaying is provided, including: acquiring a target picture including information to be prompted; processing the target picture to obtain a prompting picture; and displaying the prompting picture on a screen interface.

Alternatively, acquiring a target picture including: taking a screenshot of information to be prompted on the current interface to obtain the target picture; or photographing a selected object to obtain the target picture; or generating the target picture according to drawing operations on a preset interface.

Alternatively, processing the target picture to obtain a prompting picture including: according to a received operating instruction for the target picture from a user, executing processing operations corresponding to the operating instruction on the target information, the operating instruction including an instruction corresponding to at least one of the following operations: cutting, marking, and scrawling.

Alternatively, processing the target picture to obtain a prompting picture including: according to display requirement parameters of the screen interface, automatically processing the target picture to obtain the prompting picture.

Alternatively, the screen interface including: a lock screen interface and/or a home screen interface.

Alternatively, when the number of the prompting pictures is at least two, displaying the prompting pictures on the screen interface including: according to the time of obtaining the prompting pictures, arranging and displaying the prompting pictures on the screen interface.

Alternatively, when the number of the prompting pictures is at least two, displaying the prompting pictures on the screen interface including: acquiring the marking time of the prompting pictures, the marking time including: the processing time and/or prompting time of the backlogs corresponding to the prompting pictures; and according to the marking time, displaying the prompting pictures on the screen interface.

According to the second aspect of the embodiment of the present disclosure, an electronic device for information displaying is provided, including: at least one processor; and a memory communicably connected with the at least one processor for storing instructions executable by the at least one processor, wherein execution of the instructions by the at least one processor causes the at least one processor to: acquiring a target picture comprising information to be prompted; processing the target picture to obtain a prompting picture; and displaying the prompting picture on a screen interface.

Alternatively, the execution of the instructions by the at least one processor causes the at least one processor to: taking a screenshot of information to be prompted on the current interface to obtain the target picture; or photographing a selected object to obtain the target picture; or generating the target picture according to drawing operations on a preset interface.

Alternatively, the execution of the instructions by the at least one processor causes the at least one processor to: according to a received operating instruction for the target picture from a user, executing processing operations corresponding to the operating instruction on the target information, the operating instruction including an instruction corresponding to at least one of the following operations: cutting, marking, and scrawling.

Alternatively, the execution of the instructions by the at least one processor causes the at least one processor to: according to display requirement parameters of the screen interface, automatically processing the target picture to obtain the prompting picture.

Alternatively, the screen interface comprises: a lock screen interface and/or a home screen interface.

Alternatively, the execution of the instructions by the at least one processor causes the at least one processor to: when the number of the prompting pictures is at least two, the displaying the prompting pictures on the screen interface comprises: according to the time of obtaining the prompting pictures, arranging and displaying the prompting pictures on the screen interface.

Alternatively, the execution of the instructions by the at least one processor causes the at least one processor to: when the number of the prompting pictures is at least two, the displaying the prompting pictures on the screen interface comprises: acquiring the marking time of the prompting pictures, the marking time including: the processing time and/or prompting time of the backlogs corresponding to the prompting pictures; and according to the marking time, displaying the prompting pictures on the screen interface.

According to the third aspect of the embodiment of the present disclosure, a non-transitory computer-readable storage medium is provided, the non-transitory computer-readable storage medium storing executable instructions that, when executed by an electronic device, cause the electronic device to: acquiring a target picture including information to be prompted; processing the target picture to obtain a prompting picture; and displaying the prompting picture on a screen interface.

The technical solution provided in the embodiment of the present disclosure may comprise the following beneficial effects: for a backlog required to be prompted, a user does not need to manually input text information of the backlog, and instead the backlog is displayed on the screen interface of a mobile terminal by way of pictures and is prompted at an obvious position to prevent the user from forgetting important affairs and reduce user input at the same time, so that the method is simple and convenient to operate, the time for the user to set a prompt is saved, the prompting efficiency is improved, and better user experience for the mobile terminal is achieved.

It should be appreciated that the general description above and the detailed description hereinafter are only exemplary and explanatory, and cannot limit the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of the method for information displaying according to the embodiment of the present disclosure.

FIGS. 2A-2C are schematic diagrams of obtaining the prompting picture according to the embodiment of the present disclosure.

FIGS. 3A-3C are schematic diagrams of obtaining the prompting picture according to another embodiment of the present disclosure.

FIGS. 4A-4C are schematic diagrams of obtaining the prompting picture according to another embodiment of the present disclosure.

FIG. 5 is a schematic diagram of displaying the prompting picture on the lock screen interface according to the embodiment of the present disclosure.

FIG. 6 is a flow diagram of the method for information displaying according to another embodiment of the present disclosure.

FIG. 7 is a block diagram of the electronic device for information displaying according to the embodiment of the present disclosure.

FIG. 8 is a block diagram of the acquisition module according to the embodiment of the present disclosure.

FIG. 9 is a block diagram of the display module according to the embodiment of the present disclosure.

FIG. 10 is a block diagram of a structure of an electronic device for information displaying.

### DETAILED DESCRIPTION

The exemplary embodiments will be described herein in details, and the examples thereof are shown in the accompanying drawings. When the following description involves the accompanying drawings, unless otherwise indicated, like reference numbers in different accompanying drawings represent like or similar elements. The implementation methods described in the following exemplary embodiments do not represent all implementation methods consistent with the present disclosure. Instead, they are only examples of devices and methods that are consistent with some aspects of the present disclosure, as detailed in the appended claims.

The technical solution provided in the embodiment of the present disclosure is applied to a mobile terminal.

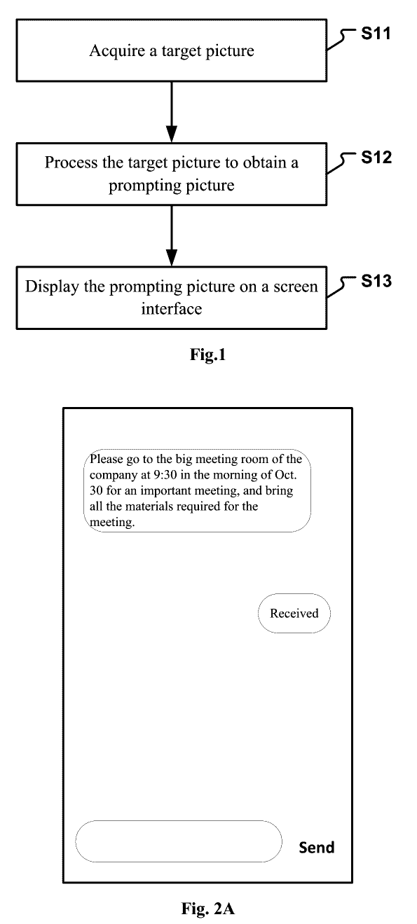

FIG. 1 is a flow diagram of the method for information displaying according to the embodiment of the present disclosure, and as shown in FIG. 1, the method includes the following steps S11-S13:

S11, a target picture is acquired.

S12, the target picture is processed to obtain a prompting picture.

S13, the prompting picture is displayed on a screen interface.

In this embodiment, for a backlog required to be prompted, a user does not need to manually input text information of the backlog, and instead the backlog is displayed on the screen interface of a mobile terminal by way of pictures and is prompted at an obvious position to prevent the user from forgetting important affairs and reduce user input at the same time, so that the method is simple and convenient to operate, the time for the user to set a prompt is saved, the prompting efficiency is improved, and better user experience for the mobile terminal is achieved.

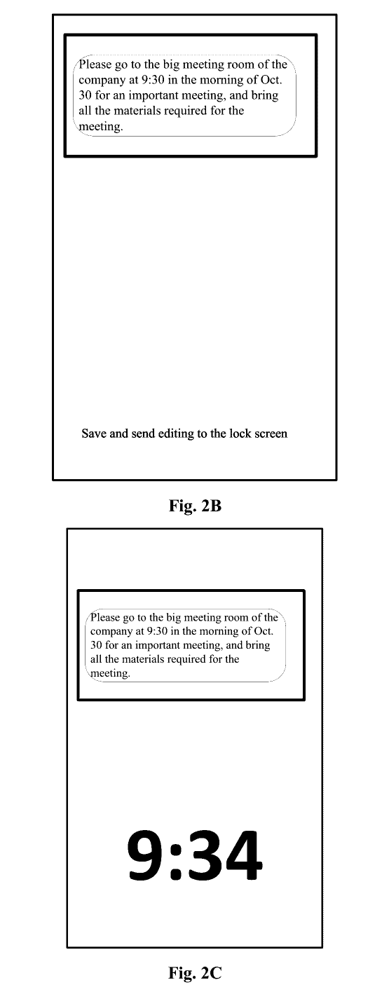

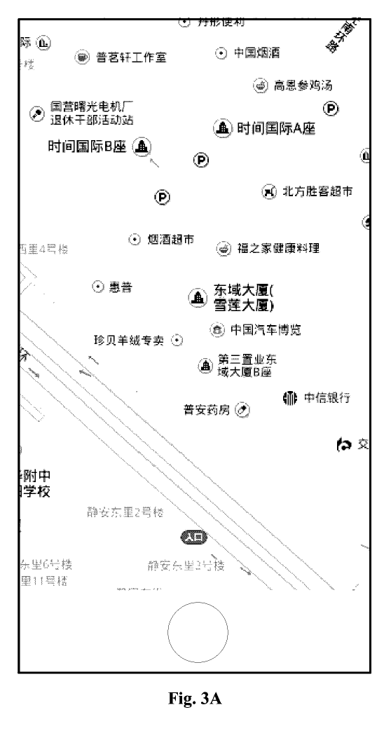

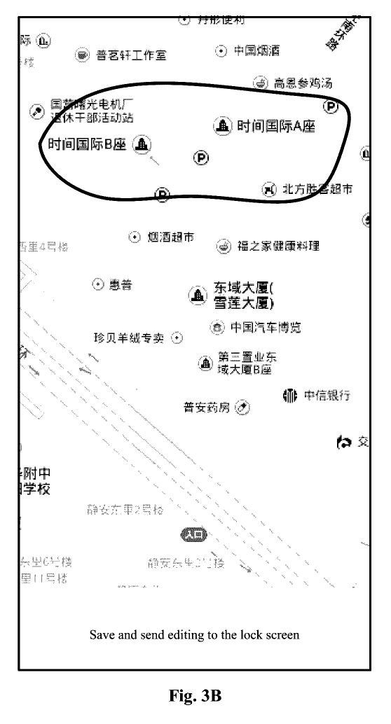

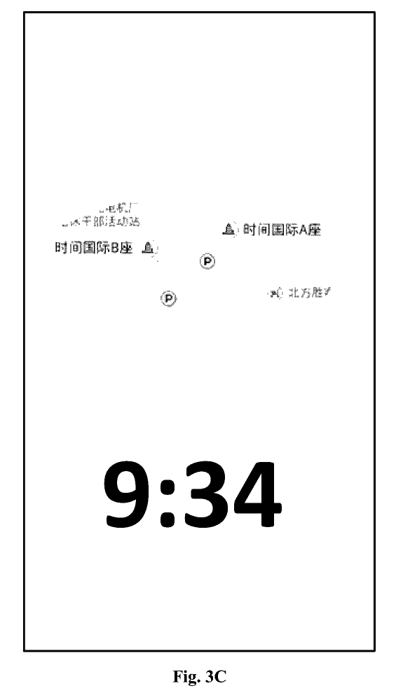

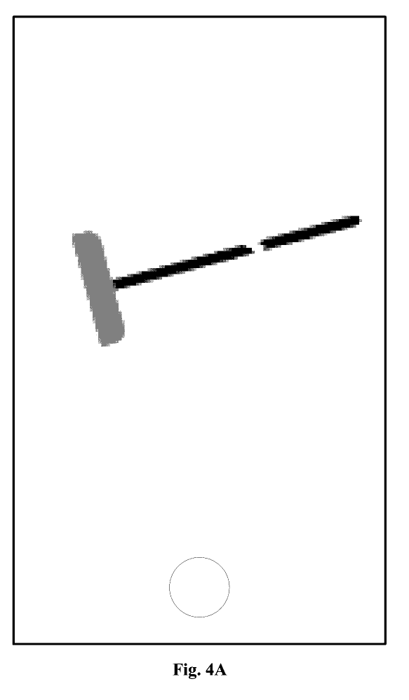

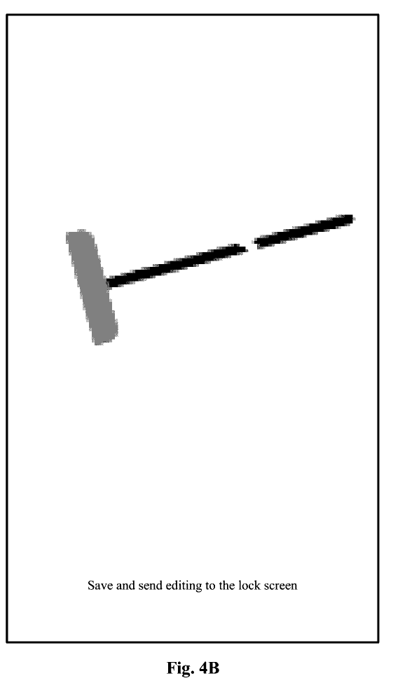

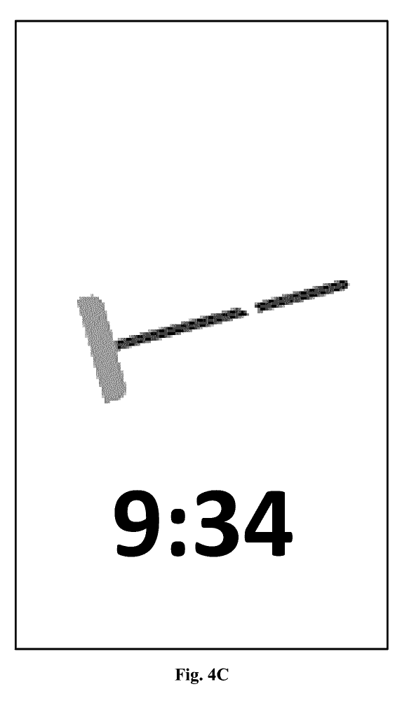

As shown in FIG. 2A, FIG. 3A and FIG. 4A, in another embodiment, acquiring a target picture includes at least one of the following ways.

The first way: a screenshot of the information on the current interface is taken to obtain the target picture.

For example, for the situations where notification information is received through an e-mail or a short message, a screenshot of the current interface displaying the notification information is taken. As another example, if a package of online shopping needs to be received, a screenshot of the order interface on the shopping website can be taken. As another example, if the user needs to go to a place for assembly, a screenshot of the map in the interface can be taken.

The second way: a selected object is photographed to obtain the target picture.

For example, if the user needs to go to a supermarket to buy foods, a photo of a pot or bowls can be taken. As another example, if the user needs to take medicine regularly, a photo of a medicine can be taken.

The third way: the target picture is generated according to drawing operations on a preset interface.

For example, an application can be provided to enable the user to generate the target picture through simple drawing operations on a home interface or a lock screen interface, e.g., if the user wants to buy flowers and send them to a friend, the user can simply draw the shape of a flower on the home interface or the lock screen interface and keep it on the home interface or the lock screen interface for prompting the user.

In another embodiment, the target picture is processed to obtain a prompting picture includes: according to a received operating instruction for the target picture from a user, executing processing operations corresponding to the operating instruction on the target information, the operating instruction including an instruction corresponding to at least one of the following operations: cutting, marking, and scrawling.

For example, as shown in FIGS. 2A-2C, it is possible to capture a number of short messages by taking a screenshot of a short message interface, the user can cut the screenshot to obtain a prompting picture so as to select an important short message to be prompted, and place the prompting picture on the screen interface.

As another example, as shown in FIGS. 3A-3C, after photographing a map, the user can circle an important position in the map, and a prompting picture is generated according to the part circled by the user and is placed on the lock screen interface to prompt the user to assemble at a certain place.

As another example, as shown in FIGS. 4A-4C, in the case that the broom in the user's home is broken and the user needs to buy a new one, the user can take a picture of the broken broom, and this picture can be directly placed on the lock screen interface to prompt the user to buy a broom.

In this embodiment, for a backlog required to be prompted, a user does not need to manually input text information of the backlog, and instead the backlog is displayed on the screen interface of a mobile terminal by way of pictures and is prompted at an obvious position to prevent the user from forgetting important affairs, and meanwhile, it is easy and convenient for the user to operate, the time for the user to set a prompt is saved, the prompting efficiency is improved, and better user experience for the mobile terminal is achieved.

In another embodiment, the target picture is processed to obtain a prompting picture includes: according to display requirement parameters of a screen interface, automatically processing the target picture to obtain the prompting picture.

For example, if the picture taken by the user is too large, the mobile terminal can automatically compress the picture according to the display requirement parameters like size or pixel requirements of screen display, to obtain a prompting picture meeting the requirements of screen display.

In another embodiment, the screen interface includes: a lock screen interface and/or a home screen interface.

For example, the user can choose to only display the prompting picture only on the home screen interface or the lock screen interface, or on the both.

In this embodiment, for a backlog required to be prompted, a user does not need to manually input text information of the backlog, and instead the backlog is displayed on the screen interface of a mobile terminal by way of pictures and is prompted at an obvious position to prevent the user from forgetting important affairs.

In another embodiment, when the number of the prompting pictures is at least two, the prompting pictures are displayed on the screen interface includes: according to the time of obtaining the prompting pictures, arranging and displaying the prompting pictures on the screen interface.

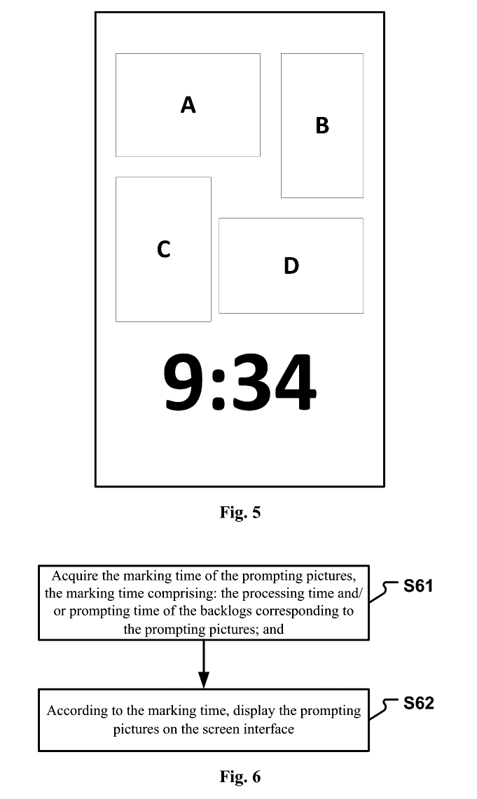

As shown in FIG. 5, the user can set the number of the prompting pictures which can be displayed on the screen interface, for example, the screen interface can display 4 prompting pictures at most, and there are 4 prompting pictures: picture A, picture B, picture C and picture D. The time of obtaining the picture A is 8:00, the time of obtaining the picture B is 9:30, the time of obtaining the picture C is 10:30, and the time of obtaining the picture D is 16:00. The four pictures can be arranged and displayed on the screen interface in chronological order.

In another embodiment, as shown in FIG. 6, when the number of the prompting pictures is at least two, the prompting pictures are displayed on the screen interface includes S61-S62:
S61, the marking time of the prompting pictures are acquired, the marking time including: the processing time and/or prompting time of the backlogs corresponding to the prompting pictures.
S62, according to the marking time, the prompting pictures are displayed on the screen interface.

For example, there are 4 prompting pictures and the user can mark the processing time and prompting time of backlogs on the prompting pictures. The four prompting pictures can be displayed on a screen at the same time according to the marking time, or alternately displayed in turns according to the marking time, and only one prompting picture is displayed on the screen at the same moment.

In this embodiment, through a variety of display modes of the prompting pictures, the backlogs are displayed at obvious positions on the screen interface of a mobile terminal to prevent the user from forgetting important affairs, and good user experience degree is achieved.

Described below is an embodiment of the device of the present disclosure, which can be used for implementing the embodiments of the method of the present disclosure.

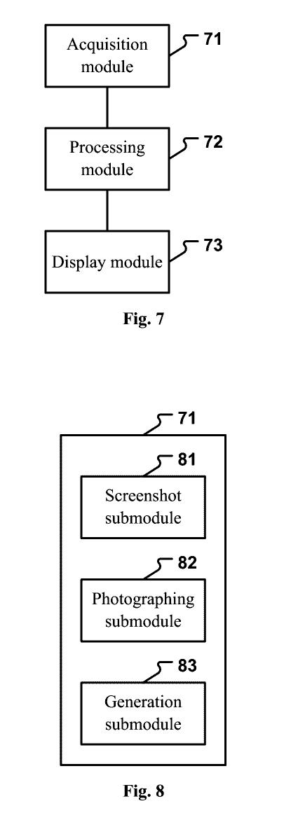

FIG. 7 is a block diagram of the electronic device for information displaying according to the embodiment of the present disclosure, and the device can become a part or all of electronic equipment through software, hardware or a combination of the both. As shown in FIG. 7, the electronic device for information displaying includes: an acquisition module 71, a processing module 72 and a display module 73.

The acquisition module 71 is used for acquiring a target picture. The processing module 72 is used for processing the target picture to obtain a prompting picture. The display module 73 is used for displaying the prompting picture on a screen interface.

As shown in FIG. 8, alternatively, the acquisition module 71 includes at least one of the following submodules: a screenshot submodule 81, which is used for taking a screenshot of information on the current interface to obtain the target picture; a photographing submodule 82, which is used for photographing a selected object to obtain the target picture; and a generation submodule 83, which is used for generating the target picture according to drawing operations on a preset interface.

Alternatively, the processing module 72 is used for executing, according to a received operating instruction for the target picture from a user, processing operations corresponding to the operating instruction on the target information, the operating instruction including an instruction corresponding to at least one of the following operations: cutting, marking, and scrawling.

Alternatively, the processing module 72 is used for automatically processing the target picture to obtain the prompting picture, according to display requirement parameters of a screen interface.

Alternatively, the screen interface includes: a lock screen interface and/or a home screen interface.

As shown in FIG. 9, alternatively, the display module 73 includes: an acquisition submodule 91, which is used for acquiring the marking time of the prompting pictures, the marking time including: the processing time and/or prompting time of the backlogs corresponding to the information to be prompted; and a display submodule 92, which is used for displaying the prompting pictures on the screen interface, according to the marking time.

In this embodiment, for a backlog required to be prompted, a user does not need to manually input text information of the backlog, and instead the backlog is displayed on the screen interface of a mobile terminal by way of pictures and is prompted at an obvious position to prevent the user from forgetting important affairs and reduce user input at the same time, so that the method is simple and convenient to operate, the time for the user to set a prompt is saved, the prompting efficiency is improved, and better user experience for the mobile terminal is achieved.

After considering the description and practicing the disclosure disclosed herein, it would be easy for those skilled in the art to conceive of other implementations of the present disclosure. The present application is intended to cover any variants, applications or adaptive changes of the present disclosure, and these variants, applications or adaptive changes follow the general principle of the present disclosure and include common general knowledge or conventional technical means in the technical field that is not disclosed by the present disclosure. The description and embodiments are only considered to be exemplary, and the actual scope and spirit of the present disclosure are indicated by the following claims.

It will be appreciated that the present disclosure is not limited to the accurate structure already described hereinabove and shown in the accompanying drawings, and various modifications and changes can be made without departing from its scope. The scope of the present disclosure is limited by the appended claims only.

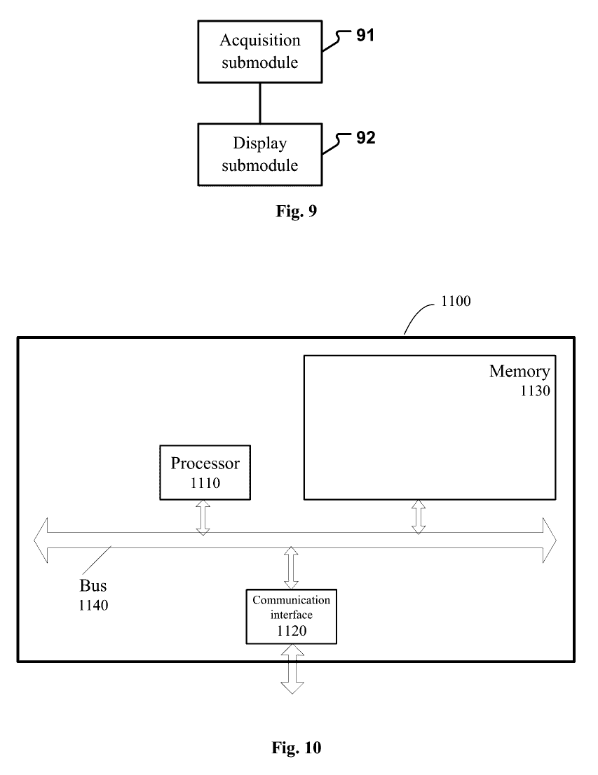

FIG. 10 illustrates a block diagram of a structure of an electronic device for information displaying in another embodiment of the present disclosure. The electronic device for information displaying 1100 may be a host server, a personal computer (PC), or a portable computer or terminal and the like with computing power. The specific embodiments of the present disclosure do not limit concrete implementation of computing nodes.

The electronic device for information displaying 1100 including a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element including, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present disclosure.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned program may be program codes including computer operating instructions. Specifically, the program can be used for: acquiring a target picture including information to be prompted; processing the target picture to obtain a prompting picture; and displaying the prompting picture on a screen interface.

In a possible embodiment, the acquiring a target picture including: taking a screenshot of information to be prompted on the current interface to obtain the target picture; or photographing a selected object to obtain the target picture; or generating the target picture according to drawing operations on a preset interface.

In a possible embodiment, processing the target picture to obtain a prompting picture including: according to a received operating instruction for the target picture from a user, executing processing operations corresponding to the operating instruction on the target information, the operating instruction including an instruction corresponding to at least one of the following operations: cutting, marking, and scrawling.

In a possible embodiment, processing the target picture to obtain a prompting picture including: according to display requirement parameters of the screen interface, automatically processing the target picture to obtain the prompting picture.

In a possible embodiment, the screen interface including: a lock screen interface and/or a home screen interface.

In a possible embodiment, when the number of the prompting pictures is at least two, the displaying the prompting pictures on the screen interface including: according to the time of obtaining the prompting pictures, arranging and displaying the prompting pictures on the screen interface.

In a possible embodiment, when the number of the prompting pictures is at least two, the displaying the prompting pictures on the screen interface including: acquiring the marking time of the prompting pictures, the marking time including: the processing time and/or prompting time of the backlogs corresponding to the prompting pictures; and according to the marking time, displaying the prompting pictures on the screen interface.

It will be appreciated by those skilled in the art that the embodiments of the present disclosure can provide a method, a system, or a computer program product. Therefore, the present disclosure can adopt a form of full-hardware embodiments, full-software embodiments, or embodiments with combination of hardware and software. Moreover, the present disclosure can adopt a form of the computer program product implemented on one or more computer-available storage media (including but not limited to a disk memory and an optical memory, etc.) containing computer-available program codes.

The present disclosure is described with reference to the flow diagram and/or block diagram of the method, the device (system), and the computer program product according to embodiments of the present disclosure. It should be appreciated that every flow and/or block in the flow diagram and/or block diagram, and the combination of the flows and/or blocks in the flow diagram and/or block diagram can be implemented by computer program instructions. These computer program instructions can be provided to a processor of a general-purpose computer, a special-purpose computer, an embedded type processor or other programmable data processing equipment to create a machine so as to ensure that the instructions executed by the processor of a computer or other programmable data processing equipment create a device for realizing a specified function in one or more flows of the flow diagram and/or one or more blocks of the block diagram.

These computer program instructions also can be stored in a computer-readable memory which can guide the computer or other programmable data processing equipment to work in a specific mode, so that the instructions stored in the computer-readable memory generate a manufactured product including an instruction device which realizes the specific function in one or more flows of the flow diagram and/or one or more blocks of the block diagram.

In addition, the embodiment of the present disclosure provides a non-transitory computer-readable storage medium storing executable instructions that, when executed by an electronic device, cause the electronic device to execute the processing method in the case of any method embodiment mentioned above.

These computer program instructions also can be loaded to the computer or other programmable data processing equipment to ensure that a series of operation steps are executed on the computer or other programmable data processing equipment so as to generate computer-implementing processing, so that the instructions executed on the computer or other programmable data processing equipment provide steps for realizing the specific function in one or more flows of the flow diagram and/or one or more blocks of the block diagram.

The above descriptions of the specific exemplary embodiments of the present disclosure are for the purpose of explanation and illustration. These descriptions do not intend to limit the present disclosure as a disclosed precise form, and it is apparent that, in accordance with the above instructions, a variety of changes and variations can be carried out. The purpose of selecting and describing the exemplary embodiments is to explain the specific principles and practical application of the present disclosure, so that those skilled in the art to can achieve and use a variety of different exemplary embodiments of the present disclosure and a variety of options and changes. The scope of the present disclosure is intended to be limited by the claims and an equivalent form thereof.

What is claimed is:

1. A method for information displaying, wherein, comprising:
acquiring a target picture comprising information to be prompted;
processing the target picture to obtain a prompting picture; and
displaying the prompting picture on a screen interface.

2. The method according to claim 1, wherein, the said acquiring a target picture comprises:
taking a screenshot of information to be prompted on the current interface to obtain the target picture; or
photographing a selected object to obtain the target picture; or
generating the target picture according to drawing operations on a preset interface.

3. The method according to claim 1, wherein, processing the target picture to obtain a prompting picture comprises:
according to a received operating instruction for the target picture from a user, executing processing operations corresponding to the operating instruction on the target information, the operating instruction comprising an instruction corresponding to at least one of the following operations: cutting, marking, and scrawling.

4. The method according to claim 1, wherein, processing the target picture to obtain a prompting picture comprises:
according to display requirement parameters of the screen interface, automatically processing the target picture to obtain the prompting picture.

5. The method according to claim 1, wherein, the screen interface comprises: a lock screen interface and/or a home screen interface.

6. The method according to claim 1, wherein, when the number of the prompting pictures is at least two, the said displaying the prompting pictures on the screen interface comprises:
according to the time of obtaining the prompting pictures, arranging and displaying the prompting pictures on the screen interface.

7. The method according to claim 1, wherein, when the number of the prompting pictures is at least two, the said displaying the prompting pictures on the screen interface comprises:
acquiring the marking time of the prompting pictures, the marking time comprising: the processing time and/or prompting time of the backlogs corresponding to the prompting pictures; and
according to the marking time, displaying the prompting pictures on the screen interface.

8. An electronic device for information displaying, comprising:
at least one processor; and
a memory communicably connected with the at least one processor for storing instructions executable by the at least one processor, wherein execution of the instructions by the at least one processor causes the at least one processor to:
acquiring a target picture comprising information to be prompted;
processing the target picture to obtain a prompting picture; and
displaying the prompting picture on a screen interface.

9. The electronic device according to claim 8, wherein execution of the instructions by the at least one processor causes the at least one processor to:
taking a screenshot of information to be prompted on the current interface to obtain the target picture; or
photographing a selected object to obtain the target picture; or
generating the target picture according to drawing operations on a preset interface.

10. The electronic device according to claim 8, wherein execution of the instructions by the at least one processor causes the at least one processor to:
according to a received operating instruction for the target picture from a user, executing processing operations corresponding to the operating instruction on the target information, the operating instruction comprising an instruction corresponding to at least one of the following operations: cutting, marking, and scrawling.

11. The electronic device according to claim 8, wherein execution of the instructions by the at least one processor causes the at least one processor to:
according to display requirement parameters of the screen interface, automatically processing the target picture to obtain the prompting picture.

12. The electronic device according to claim 8, wherein, the screen interface comprises: a lock screen interface and/or a home screen interface.

13. The electronic device according to claim 8, wherein execution of the instructions by the at least one processor causes the at least one processor to: when the number of the prompting pictures is at least two, the said displaying the prompting pictures on the screen interface comprises:
according to the time of obtaining the prompting pictures, arranging and displaying the prompting pictures on the screen interface.

14. The electronic device according to claim 8, wherein execution of the instructions by the at least one processor causes the at least one processor to: when the number of the prompting pictures is at least two, the said displaying the prompting pictures on the screen interface comprises:
acquiring the marking time of the prompting pictures, the marking time comprising: the processing time and/or prompting time of the backlogs corresponding to the prompting pictures; and
according to the marking time, displaying the prompting pictures on the screen interface.

15. A non-transitory computer-readable storage medium storing executable instructions that, when executed by an electronic device, cause the electronic device to:
acquiring a target picture comprising information to be prompted;
processing the target picture to obtain a prompting picture; and
displaying the prompting picture on a screen interface.
